(19) United States
(12) Patent Application Publication
(10) Pub. No.: US 2006/0101257 A1
(43) Pub. Date: May 11, 2006

(54) System and method to provide a processor with dynamic instruction set and decoder

(76) Inventor: Frans Sijstermans, Los Altos, CA (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/221,678

(22) Filed: Sep. 7, 2005

Related U.S. Application Data
(60) Provisional application No. 60/607,848, filed on Sep. 7, 2004.

(51) Int. Cl. G06F 9/44

(52) U.S. Cl. 712/248; 712/226

(57) ABSTRACT

A system and method to provide a processor with a dynamic instruction set and decoder is provided. One embodiment provides a micro-processor with a dynamic instruction set, the instruction set is updated on the fly. A single instruction can be interpreted in many different ways depending on the current configuration of the instruction decoder. This configuration is not restricted to a single or a few modes, but can take many different values. The configuration can be adapted by explicit instructions in the instruction stream or as a side effect of other instructions being executed. The advantage of updating the instruction set is in the coding efficiency. E.g., the total number of instructions that can be executed by the functional units may exceed the instruction set size, which can be limited by the maximum instruction (bit string) length. By adapting the instruction set dynamically, the instructions that are important for certain functions can be made available when those functions are executed but be swapped out while other functions are executed. In that way, the instruction set is at any time optimal for the task at hand.

### RELATED APPLICATIONS

The present application claims the benefit of the prior filed provisional application entitled Processor with Dynamic Instruction Set and Decoder filed on Sep. 7, 2004 and assigned Ser. No. 60/607,848 which is hereby incorporated in its entirety.

### BACKGROUND OF THE INVENTION

A micro-processor can be thought to consist of at least three parts:

1. An instruction source, e.g., an internal or external instruction memory/cache, that produces a stream of instructions;

2. An instruction decoder that translates this stream of instructions into a set of control signals;

3. A collection of one or more functional units that under control of the signals generated by the instruction decoder execute the instructions.

Any micro-processor today (e.g., CPU, DSP, or micro-controller) has these three elements. Every instruction is represented by a bit string. Execution of an instruction will affect the internal state of the micro-processor in a pre-defined way, called the semantics of the instruction. In existing micro-processors, the semantics of instructions are fixed, i.e., if the same instruction is executed twice, the instruction decoder will translate the instruction in the same set of control signals and the state of the micro-processor will be affected in the same way both times. A variation on this theme are architectures which supports a small set of fixed instruction sets, e.g., a compressed mode and an uncompressed mode or a legacy and a new instruction set mode.

### SUMMARY

In one embodiment, a system and method to provide a processor with a dynamic instruction set and decoder is provided. One embodiment provides a micro-processor with a dynamic instruction set, the instruction set is updated on the fly. A single instruction can be interpreted in many different ways depending on the current configuration of the instruction decoder. This configuration is not restricted to a single or a few modes, but can take many different values. The configuration can be adapted by explicit instructions in the instruction stream or as a side effect of other instructions being executed. The advantage of updating the instruction set is in the coding efficiency; e.g., the total number of instructions that can be executed by the functional units may exceed the instruction set size, which can be limited by the maximum instruction (bit string) length. By adapting the instruction set dynamically, the instructions that are important for certain functions can be made available when those functions are executed but be swapped out while other functions are executed. In that way, the instruction set is at any time optimal for the task at hand.

### BRIEF DESCRIPTION OF FIGURES

FIG. 1 provides a block diagram of a node architecture, in accordance with one embodiment; and

FIG. 2 provides a block diagram of a signal processor, in accordance with one embodiment;

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

In one embodiment, a micro-processor with a dynamic instruction set is provided. The instruction set is updated on the fly. A single instruction can be interpreted in many different ways depending on the current configuration of the instruction decoder. This configuration is not restricted to a single or a few modes, but can take many different values. The configuration can be adapted by explicit instructions in the instruction stream or as a side effect of other instructions being executed. The advantage of updating the instruction set is in the coding efficiency. E.g., the total number of instructions that can be executed by the functional units may exceed the instruction set size, which can be limited by the maximum instruction (bit string) length. By adapting the instruction set dynamically, the instructions that are important for certain functions can be made available when those functions are executed but be swapped out while other functions are executed. In that way, the instruction set is at any time optimal for the task at hand.

One application for this invention is in the context of video compression and decompression. In this application, there are a number of different standards and within each standard, a number of different picture types. Each of these standards and picture types uses different algorithms, best supported by different instructions. The instruction set can thus be adapted at the start of processing a new frame to perfectly match the given standard and picture type.

Typically processors have a fixed instruction set. When an instruction is executed, the instruction always executes the same operation. In one embodiment, the present invention addresses an issue of instruction density (how much memory space is taken by the instructions). In one embodiment, the processor has a relatively small amount of bytes available per instruction. As a result, in one embodiment, the instruction set of the processor is changed depending really on what kind of code is being executed.

In one embodiment, the instructions are changed on the fly. A few instructions could be changed ahead of time before they are executed. Consider by way of example, an instruction decoder viewed as a table that takes for example four bytes input and produces a 16 byte output. As a result, the number of instructions that are available is limited to two to the power of four, resulting in 16 different instructions being available for, but the total amount that you can reach is two to the power of 16, which is 64,000 or something like that, so we would be changing the contents of that table on-the-fly, depending on the node that we are using, and you could have like two tables which are completely independent and I switch from one table to the other table and you could also say well I changed some of the entries in the table.

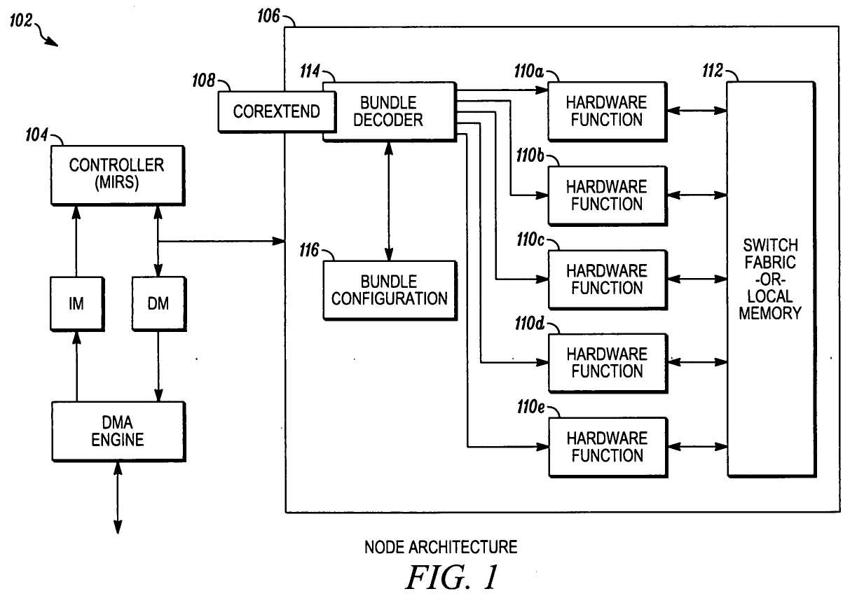

In one embodiment, as illustrated in FIG. 1, there is a control processor 104 and a signal processor 106, also referred herein as a vector processor. The control processor 104 determines the instruction set at any moment for the vector processor.

In one embodiment, the control processor 104 is aware of the algorithm that is currently being executing, such as different video standards. For example, the control processor 104 knows whether its doing MPEG-2, or whether its Media 9, or 264 decompression and based on the type of video standard the control processor 104 changes the instructions, because the control processor 104 knows what kind of instructions the control processor 104 wants in the signal processor 106 to perform the respective video standard. As such, in one embodiment, the signal processor 106 could be considered the slave processor to the control processor 104.

In one embodiment, the software being executed identifies what algorithm is being executed at a certain point in time and based on that the control processor 104 is able to change/update the instruction set. In one embodiment, the changing/updating is a dynamic process. As an example, execution could be somewhere in the middle of MPEG-2 and the next operation requires a certain operation that would necessitate some of the instructions be changed. As a result, in one embodiment, a relatively large collection of instructions that are available, and at any given time only a subset of instructions can be used, and the subset being used is able to be changed dynamically by the control processor 104.

In particular, in one embodiment, a relatively large set of instructions are available for the signal processor 106. In one embodiment, the signal processor 106 can do very many different instructions, some of them specialized, very difficult, and so that of that a large set you only need a small subset at any point in time and the control processor 104 knows which subset the control processor 104 is going to use because the control processor 104 basically uses this signal processor 106 as a slave. By way of example, the stream of instructions being executed indicates to the control processor 104 that an IDCT is to be executed as part of the process. For the IDCT certain instructions are needed, which may be identified by the instructions being executed before they are needed. In response, the control processor 104 indicates to the instruction decoder for the signal processor 106 that some of the instructions recently executed are not needed any more and those instructions are to be replaced them with the new instructions. Once the instructions identified as no longer needed are no longer used, a configuration stage configures the instruction set and then a new stage begins where the new instructions are to be used begins (i.e., IDCT). The process is also referenced herein as a bundle decoder 114 configuration, which can be viewed as an execution stage. The bundle configuration 114 changes the instruction decoder of signal processor 106 and then the bundle itself uses those instructions.

Referring to FIG. 1, one embodiment of a processor 102 (also referenced as Node architecture) is illustrated that includes the controller side and the signal processing side. The processor includes the corextend 108 108, which in one embodiment is the MIPS manner of extending the instruction set. The signal processor 106 104 shown has a number of hardware functions 110a-3. In one embodiment there are a number of hardware functions 110a-e that are connected by a switch fabric 112 and the bundle decoder 114 114 basically sends instructions to all of these hardware functions. In one embodiment, each of these hardware functions receives their own piece of an instruction.

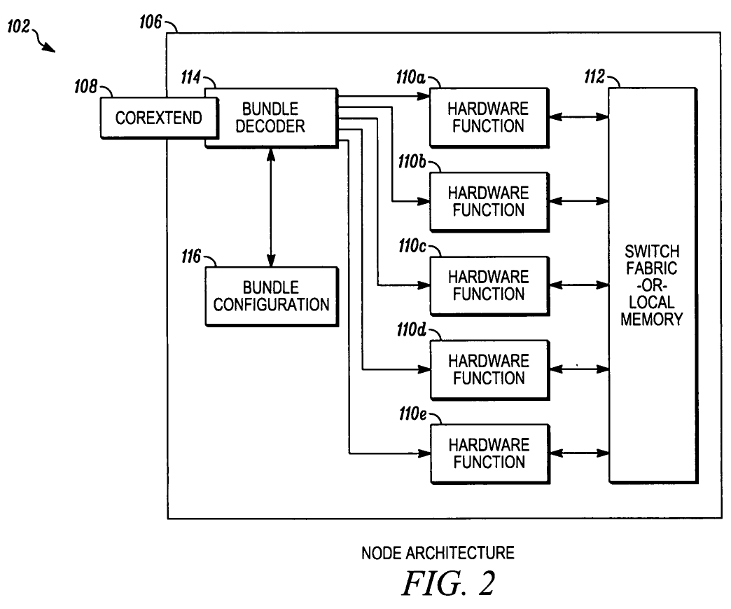

In one example, as illustrated in FIG. 2, the hardware functions could include such functions as a multiply vertical filter, horizontal filter and macro block store operation, etc., with each part of the instruction set. In the example, each of the hardware functions 110a-e would receive a 32 byte instruction. In the case of the five hardware functions, the number of bytes used to specify one instruction would be 160 bytes. In one embodiment, the bundle decoder 114 114 takes in 16 bytes and turns it into 160 bytes vector. As a result, a relatively small subset of these 160 different instructions can be used (e.g., 2 to the power of 16).

In one embodiment, the processor dynamically changes which instructions are to be used via the bundle configuration 114 116 to reconfigure the bundle decoder 114 114. In one embodiment, the bundle configuration 114 116 directs how the small amount of bytes are mapped into the larger amount of bytes.

In one embodiment, the bundle decoder 114 is reconfigured with instructions within the code. Alternatively, the reconfiguration could be done via a separate path not within the code but rather via MMIO (memory map input/output). MMIOs typically operate, by way of example, something like “do a write to a certain address with a certain value. So these addresses would be pointing to this register, these table entries.

In one embodiment, the control processor 104 is executing a stream of instructions, which may include a “write” signal processing instruction. As a result, the control processor 104's own instructions are executed locally on the control processor 104 (e.g., adds or shifts). Then there is a separate set of instructions which are those corextend 108 instructions which the control processor 104 doesn't execute, but instead sends to the signal processor 106 for execution. So one way of changing it is the signal processor 106 has a special instruction that changes its own instruction decoder. Another way is the control processor 104 executes store operations, some of the store operations could be an MMIO operation. In that case if you look at the instruction stream, it could be control, control, control and then its actually doing signal processor 106 operations and then goes back to control operations. So one way of changing it would include one of these signal processor 106 operations changes the decoder. Another way could be that some of these control operations change the instruction decoder and that is typically via an MMIO operation. If you do it by a control operation, a store operation would be used via an MMIO which would go outside of this instruction stream. As a result, in one embodiment, it may appear as if you are writing a value to memory but actually the value of the instruction decoder is being changed. Alternatively, a signal processor 106 operation could be used to change the instruction decoder.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.), etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in them selves recite only those features regarded as essential to the invention.

It is clear that many modifications and variations of this embodiment may be made by one skilled in the art without departing from the spirit of the novel art of this disclosure.

What is claimed is:

1. A method comprising:
A processor updating an instruction set dynamically.

2. The method of claim 1, wherein the updating of the instruction set occurs during execution of an instruction stream that includes instructions from the instruction set.

3. The method of claim 2, wherein an instruction of the instruction set is to be dependant, in one of a plurality of ways, on a current configuration of an instruction decoder of the processor.

4. The method of claim 3, further comprising selecting the configuration from one of at least five values.

5. The method of claim 4, further comprising changing the configuration by explicit instructions in an instruction stream being executed.

6. The method of claim 4, further comprising changing the configuration in response to a side effect of a separate instruction being executed.

7. The method of claim 4, further comprising changing the configuration in response to an MMIO (memory map input/output) operation.

8. The method of claim 6, wherein a quantity of instructions of the instruction set that can be executed by a fixed set of functional units, is greater than the instruction set size as limited by an instruction length of the instructions of the instruction set.

9. The method of claim 6, wherein the dynamic updating of the instruction set during execution of instructions from the instruction set includes updating instructions of the instruction set during execution of one of a video compression or video decompression process.

10. A machine-readable medium having stored thereon a set of instructions which when executed, perform a method comprising:
A processor updating an instruction set dynamically.

11. The machine-readable medium of claim 10, wherein the updating of the instruction set occurs during execution of an instruction stream that includes instructions from the instruction set.

12. The machine-readable medium of claim 11, wherein an instruction of the instruction set is to be dependant, in one of a plurality of ways, on a current configuration of an instruction decoder of the processor.

13. The machine-readable medium of claim 12, further comprising selecting the configuration from one of at least five values.

14. The machine-readable medium of claim 13, further comprising changing the configuration by explicit instructions in an instruction stream being executed.

15. The method of claim 13, further comprising changing the configuration in response to a side effect of a separate instruction being executed.

16. The machine-readable medium of clam 13, further comprising changing the configuration in response to an MMIO (memory map input/output) operation.

17. The machine-readable medium of claim 13, wherein a quantity of instructions of the instruction set that can be executed by a fixed set of functional units, is greater than the instruction set size as limited by an instruction length of the instructions of the instruction set.

18. The machine-readable medium of claim 13, wherein the dynamic updating of the instruction set during execution of instructions from the instruction set includes updating instructions of the instruction set during execution of one of a video compression or video decompression process.

19. A system comprising:
A means for updating an instruction set dynamically during execution of an instruction stream that includes instructions from the instruction set.

20. The system of claim 19, wherein an instruction of the instruction set is to be dependant, in one of a plurality of ways, on a current configuration of an instruction decoder of a processor.
